(19) United States
(12) Patent Application Publication
(10) Pub. No.: US 2013/0031021 A1
(43) Pub. Date: Jan. 31, 2013

(54) METHOD AND SYSTEM FOR ANALYZING INVESTMENTS AND INVESTMENT PLANS AND RISKS AND RELATED BUSINESSES WITH DYNAMIC DECISION MAKING

(71) Applicants: Timo Tapio Salminen, Helsinki (FI); Osmo Visa Viktor Jauri, Kauniainen (FI)

(72) Inventors: Timo Tapio Salminen, Helsinki (FI); Osmo Visa Viktor Jauri, Kauniainen (FI)

(73) Assignee: MODEL IT LTD, Helsinki (FI)

(21) Appl. No.: 13/556,292

(22) Filed: Jul. 24, 2012

Related U.S. Application Data
(60) Provisional application No. 61/511,443, filed on Jul. 25, 2011.

(51) Int. Cl. G06Q 40/06

(52) U.S. Cl. 705/36 R

(57) ABSTRACT

Systems, methods and computer program products for analyzing stochastic characteristics, including one or more subsystem for forecasting financial statements and financial ratios' probability distributions and configured for at least one of: analyzing insurance contracts and portfolios without simplifying contract and product terms and conditions; studying and illustrating financial statement probability distributions; analyzing insurance portfolios by creating net asset value distributions thereof without deterministic assumptions; modeling to support asset and liability management, wherein both assets and liabilities are simulated simultaneously and decisions are based on joint probability distributions thereof; and modeling to study effects of model specification changes by implementing new model definitions and by rerunning the model with constant random number generator seed.

### CROSS REFERENCE TO RELATED DOCUMENTS

The present invention is related to U.S. Provisional Patent Application Ser. No. 61/511,443 of SALMINEN et al., entitled “METHOD AND SYSTEM FOR ANALYZING INVESTMENTS AND INVESTMENT PLANS AND RISKS AND RELATED BUSINESSES WITH DYNAMIC DECISION MAKING,” filed on Jul. 25, 2011, the entire disclosure of which is hereby incorporated by reference herein.

### BACKGROUND OF THE INVENTION

1. Field of the Invention

The present invention generally relates to analyzing stochastic characteristics of already running investments, investment plans, portfolios of those and related businesses. More particularly the invention includes a method and system for finding non-simplified probability distributions of relevant variables, including cash-flows, income, running costs, borrowing costs, profit and loss, and financial ratios, such as internal rate of return, investment net asset value, and the like.

2. Discussion of the Background

Traditionally, investment planning has been based on one or more simplifying assumptions. However, existing systems and methods for investment planning do not adequately account for measuring and managing investment risk. Therefore, there is a need for a method and system for investment planning that address the above and other problems, including measuring and managing investment risk.

### SUMMARY OF THE INVENTION

The above and other needs are addressed by embodiments of the present invention, which provide a system and method including an investment analyzing/planning model that utilizes results from stochastic analysis. The model provides tools for dynamic decision making where the original investment plan can be modified during the analysis based on set decision rules. Examples of such decisions can include decisions on, for example, additional or replicating investments, changes in product mix, changes in investment funding structure, and the like. Accordingly, the illustrative system and method can be used for investment risk analysis of single investments and/or investment plans, analysis of investment and/or investment plan portfolios for larger business entities, including corporate financial planning, and the like. Advantageously, the illustrative model can be used as a tool to analyze investment decisions without simplifications, and the like. The illustrative model allows for dynamic decision making, where new decisions can be made in the future based on set decision rules. As an illustrative example, with dynamic decision making an analysis can be created where the decision to invest, for example, on natural gas capability can be state dependent and made based on simulation scenarios where the preset conditions are met. This demonstrates that even the simplest planning variables, such as scope and timing, can employ sophisticated modeling technology and in practice can be based on many unreal simplifications. Given the vast volume of investment activities, improvements in investment analysis tools have great importance.

Accordingly, in illustrative aspects, there are provided systems, methods and computer program products for analyzing stochastic characteristics, including one or more subsystems for forecasting financial, economical and technical variables' probability distributions and configured for analyzing investments, investment plans and portfolios of those without simplifying embedded real options; analyzing investments, investment plans and portfolios of those allowing state dependent decision making during the analysis changing its course dynamically; analyzing investments, investment plans and portfolios of those by creating net asset value distributions thereof without simplifications; and modeling to study effects of model specification changes by implementing new model definitions and by rerunning the model with constant random number generator seed.

Advantageously, companies are able to measure the true market consistent value of investments, planned investments and investment portfolios, measure probability distributions of relevant variables, combine analysis, if preferred, with external capital market simulations, and base their investment planning on these results.

Accordingly, in one aspect, a system for running stochastic analysis on embedded real options, with non-simplified model is provided. By doing this the system is not subject to any simplifications that would inherent model risk.

In another aspect, it is a system for defining probability distributions of desired variables over the time-period chosen for the analysis, for the purpose of analyzing single investment or investment plan, portfolios of those or entire company. These variables include, for example, sales, profit and loss, investment payback time and money weighted return. The system also offers tools to predict probability levels for cash-flows and cumulative cash-flows that can be used to measure liquidity and insolvency risks.

In another aspect, it is a system to define market consistent economic values of investments already running or planned and portfolios of those by providing probability distributions for investment and portfolio net asset values.

In another aspect, the system provides tools and methods to create distribution based forecasts for other desired company data. Other company data refers to any desired financial, economical or technical. In a typical model, these might include, for example, forecasts for maintenance costs, depreciations, loan margins and number of personnel.

In another aspect it is a system that enables company level financial planning. The system can include methods to create economic scenarios (Economic Scenario Generator, ESG), or ESGs can externally created and read into to the system as input. ESGs commonly consist of simulated realizations of various economic and capital market related variables. Such variables commonly include, but not restrict to, stock market data, yield curve data, bonds segment data, credit spread data, inflation rates, currency rates, commodity prices and any relevant data affecting the value of investment.

The model may contain non-investment activity related data as well and the system provides tools for combining and organizing simulated and computed data in the form of financial statements. By allowing non-investment specific data import we are able to show affects of investments in larger contest, like for example at company level by providing full balance sheets.

ESG data may affect asset and liability values in the system and when combined with investment simulation it enables efficient asset and liability management and also enables financial planning based. During the analysis the system builds, at defined times, simulated balance sheets and income statements and other desired data, and allows decisions rules to be applied based on these results. Decision rules are investment or company specific rules that may change the course of the simulation, typically by creating decision on additional or new investment or by changing pricing or production volumes. Each decision following from a decision rule can be made simulation round/path specific.

The system allows changing of investment characteristics, decision making rules, stochastic models and other components of the model. This allows goal seeking for optimal structures, for example optimal investment strategies or optimal decision rules. When this goal seeking is automated and is based on set target or targets it is commonly referred as optimization.

Still other aspects, features, and advantages of the present invention are readily apparent from the following detailed description, simply by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an overview of an illustrative simulation; and

FIG. 2 is an overview of illustrative inputs and outputs.

### DETAILED DESCRIPTION OF THE INVENTION

A stochastic investment simulator system and method is described. In the following description, for purposes of explanation, numerous specific details are set forth in order to provide thorough understanding of the present invention. It is apparent to one skilled in the art, however, that the present innovation can be predicted without these specific details or with equivalent arrangement. In some instances, well-known structures and devices are shown in figures and diagrams in order to avoid unnecessarily obscuring the present invention.

The present invention includes recognition that traditionally investment planning has been based on one or more of the following simplifying assumptions (Simplifications):

Embedded real-options in investment plans are commonly either left out or replaced with simplified representations, like option pricing formulas. An example of such a real option is an option to use two alternative fuels in a power plant.

Management is not assumed to make additional decisions based on prevailing conditions inside the time horizon of an investment plan. An example of such potential decision would be a case where an already built power plant is transformed to be able to use two alternative fuels. In real life such a decision might take place if, for example, relative fuel prices change.

Interdependencies between relevant economic and financial indicators are greatly simplified or omitted. An example of such dependency might be a relationship between gross national product, level of inflation and demand and price for manufactured goods commodities.

Future changes in external conditions referred above do not affect investment plan parameters and assumptions. An example of such dependency might be a decision rule to change estimated sales volume based GDP growth.

An illustrative example, assume that a power company is planning to build a new power plant. The plant will be built to use coal for fuel. The company has an option to build the plant to be able to use natural gas also, giving the choice to switch between the two fuels. The company may build the natural gas capability in the beginning, decide to build at a later point of time or postpone the decision. In a typical investment planning case, the first complication is to determine the value of the bi-fuel option. This is typically done by using option pricing theory, where—under simplifying assumptions—a pricing formula can be derived for the value of this embedded option. A second complication is to analyze the decision to build or not, and the timing of it. In a typical analysis one might compare estimated investment costs to estimated real option value and decide to build it, if the value of the option is greater than investment cost. To study the decision of building at a later time one might compare estimated option value at a later point of time to estimated investment cost at the same time and decide based on maximizing the value between the real option and investment plan. In this type of analyses one must assume that the conditions forecasted for the decision point are deterministic and known in advance. In real life, the possible future investment decision will be based on the on the prevailing information at the time. Equally in this type of analysis one could study, instead or in addition to bi-fuel capability, building a second or third power plant based on the original investment plan.

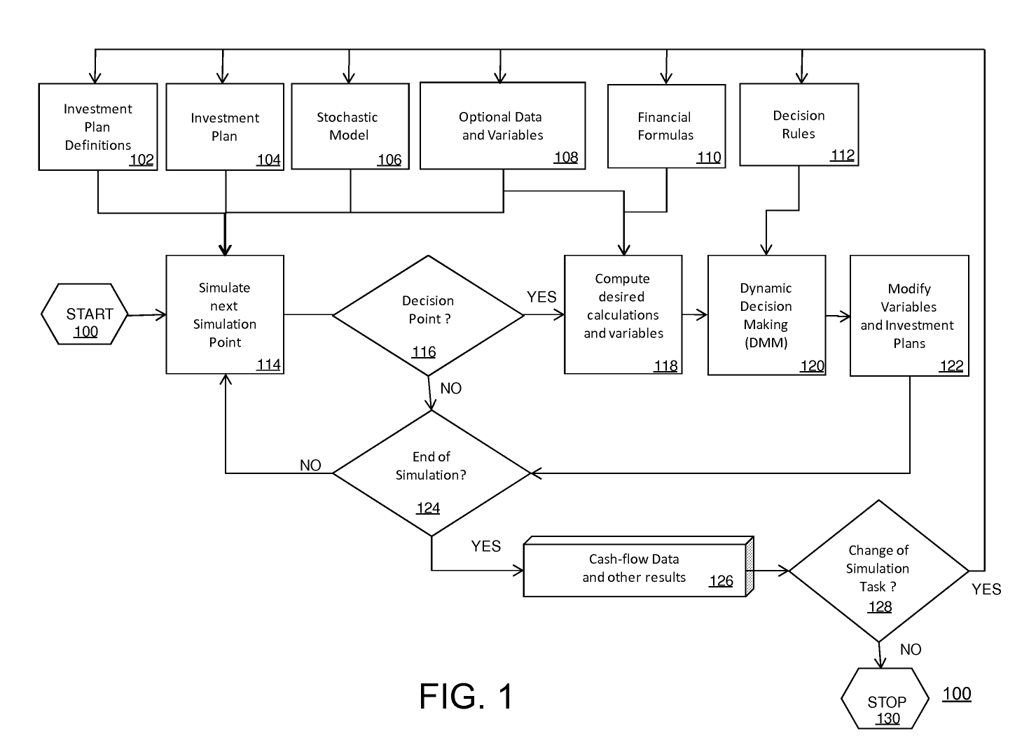

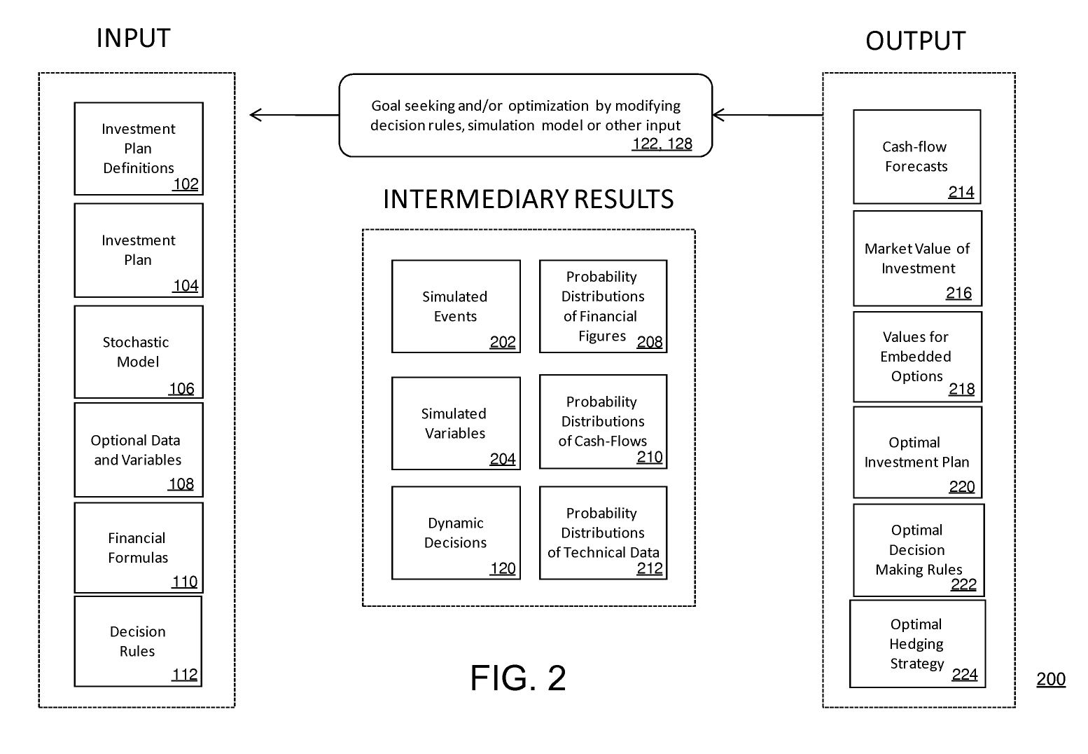

Referring now to the drawings, wherein like reference words designate identical or corresponding parts throughout the several views, FIG. 1 is an overview of an illustrative simulation; and FIG. 2 is an overview of illustrative inputs and outputs. In FIGS. 1-2, cash-flows present in the illustrative model can be deterministic or stochastic in nature, both in timing and in magnitude. They may occur once or multiple times or may not appear in single simulation round at all depending on other variables in the system. A variable can be any suitable variable the system takes as input or computes during the simulation. In a typical analysis, variables can be cash-flows, decisions, expenses, random events or deterministic forecasts. Variables can be independent or dependent on other variables. Current and time-series data of all suitable variables define the state of the simulation.

In the illustrative model, states of variables are determined in discrete points of time, simulation points, where the interval in between, the time-step, can be constant or changing. In a typical simulation, time-step can vary from 1 month to 5 years, and the like.

An investment or an investment plan can be a description of cash-flows assumed to be paid and received. Cash-flows can be deterministic or stochastic and can be given, for example, as point estimates, distributions, stochastic processes, time series forecasts, or functions of those.

Investment plan definition (step 102) is the logical representation on how the magnitude and timing of cash-flows is determined under given state of the simulation (e.g., state of the world) for an investment plan (step 104) in question. A set of investment plan definitions (step 102) represent the types of investments the model is able to analyze.

Investment plan (step 104) provides the actual values for investment plan variables, and when combined with investment plan definitions (step 102), actual magnitudes and timing of cash-flows can be computed once the state of the simulation is known. An example to illustrate the difference between investment plan definitions (step 102) and investment plan (step 104), one can define in investment plan definitions that the investment will require time and money to be built and once operable, it will be producing electricity by burning coal. The investment plan will tell how much money and time is needed and how much coal is needed for various production needs.

The separation between investment plan definitions (step 102) and investment plan (step 104) allows the system to replicate the current investment or any other suitably defined investment by introducing a new investment plan (step 104) during the simulation via dynamic decision making, if preferred. This feature can be utilized to analyze multiple investment decisions in time-space dimensions.

The simulation itself can be affected by external factors referred to as optional data and variables (step 108). Stochastic model (step 106) introduces, for example, ways on which random events affect how cash-flows directly or indirectly, for example, by affecting timing or range of produced goods or commodities, and the like. For example, the value of produced electricity can be concluded in compute of desired calculations and variables (step 118) based on simulation results, optional external data and variables (step 108) and financial formulas (step 110).

Once simulation has started and has reached a decision point (step 116), the compute desired calculations and variables (step 118) and collected and/or used for dynamic decision making (step 120). As an illustrative example. such calculations can produce financial statements, such as ROI, ROE, P/L, IRR, NPV and other financial or technical indicators, and the like.

Dynamic decision making (step 120) changes the course of the simulation at decision points (step 118) and can be executed separately for each simulation path and decision point (step 118) and can be based on set decision rules (step 112). Decision points (step 116), if any, are employed simulation points (step 114), wherein the simulation state is dependent on decisions that can alter the course of the simulation. As an illustrative example, in a typical analysis one may define that after 12 months there will be decision point (step 116), where simulated and calculated variables are organized in the form of balance sheet, income statement, net present value calculation or other desired financial, economical or technical data or indicators (step 118), and the like, to be used for dynamic decision making (step 120) and other suitable purposes, and the like.

Decision rules (step 112) employ rules that by knowing the state of the simulation and other variables are used to conclude if the course of simulation should be altered in the decision point (step 116) by introducing decisions on desired matters, such as decisions about new or additional investments, and the like. Decision rules (step 112) can be based on investment plan definition (step 102) or can be investment plan (step 104) specific or common for a set of investments, and the like.

Financial formulas (step 110) employ sets of rules that show how variables are to be organized to represent the status of the simulation in a desired form. As an illustrative example, such formulas can describe how financial statements are built based on optional data and variables (step 108) or how various financial and technical ratios and numbers are calculated, and the like.

Optional data and variables (step 108) can include (i) financial information that defines initial states of variables, (ii) any suitable external information that can be used to affect the simulation, cash-flows or values concluded in step 118, and the like. Typical examples of such data can include values of balance sheet items at the beginning of the simulation, ESG data, and the like.

Simulation refers to a method where the same task is repeated multiple times with varying input to learn system characteristics. A typical way to do a simulation is to use random number generator to create sequences of random numbers (e.g., pseudo-random numbers). Simulation can also be based on deterministic numbers, where numbers have been created in a non-random way (e.g., quasi-random numbers) or can be a combination of these, and the like.

Stochastic model (step 106) employs a set of rules for defining random variables and their behavior over time in the model. Randomness can appear in the form of random variables and stochastic processes which are not restricted into any set (e.g., random variables are not limited to a particular set of distributions nor stochastic processes are restricted in structure). It is not required that all random variables are defined in stochastic models (step 106), as they can also be imported from external sources (e.g., optional data and variables, step 108). Typically, realizations can be imported for capital market variables by letting the system know their given realization paths. A typical example of imported realizations can include capital market ESG data with yield curves, commodity prices, inflation or economic growth indicators, and the like.

Randomness is presented in the system by introducing a set of probability distributions and/or stochastic processes for desired variables that can have numerical realizations in the simulation based on pseudo- or quasi-random numbers (e.g., stochastic model, step 108). As an example, these variables can include interest rates, technical failures, expenses, inflation and demand and price for manufactured goods, and the like. A typical analysis can create 1,000, 10,000 or 100,000 realizations (e.g., simulation rounds) for each variable and for each simulation point (step 114). The simulation ends when a preset condition is met (step 124), and typically the given number of years the simulation is set to run.

The output of the simulation model can include (i) deterministic and simulation based cash-flows, which can be reported in desired dimensions (e.g., cash-flow data, step 126); (ii) simulated events and other variables (step 202, 204) (iii) dynamic decisions (step 120) and (iv) all other suitable simulation results, modified input and any information derived from same. As a clarifying example, for type (i) results, in a typical analysis can report results in a form of 3-dimensional cash-flow cube, where one dimension is cash-flow type, one dimension is simulation round, and one dimension is simulation (step 204).

An example of type (ii) results can include simulated demand for goods or simulated risk events like fire. An example of type (iii) results can include a decision to build a bi-fuel extension after for certain period of time. Type (iv) results can include other variables and calculations performed during the simulation, such as balance sheet, statement of income and financial and technical ratios (steps 208, 210, 212, 214), calculations such as market values of investment (step 216), values of embedded options (step 218), optimal investment plan (step 220), for example, including magnitude and timing of simulated investments, optimal decision making rules (step 222), optimal hedging strategy (step 224), and the like.

The illustrative model enables the user to predict financial data and associated probability distributions. Financial planning is supported, for example, where the user can modify decision rules (step 112) and other assumptions and definitions in the model (steps 102, 104, 106, 108, 110). A typical example of such goal seeking (steps 122,128) can be testing of various dividend policies, economic scenarios, commodity prices or investment strategies, and the like, against results provided by the model.

If further reruns of the model are needed, for example, for planning, budgeting or sensitivity analysis, and the like, model parameters can be changed (step 128) and the model can be rerun to observe the changes in the results (steps 202-224) with new input (steps 102, 104, 106, 108, 110, 112). If no further reruns are needed, then the simulation stops (step 130).

The computer system used to run the simulation model can include a single workstation having necessary connections to read input data, where the workstation can equally be a server, laptop computer or mainframe computer, and the like. The simulation can be divided among several processors and several computation cores in a workstation. Some parts of actual computations can be performed by dedicated devices, including graphical processing units, and the like. Simulation tasks also can be performed by external servers or can be distributed among a set of computers communicating with each other by using local-area-network, wide-area-network, wireless-local-area-network or any other suitable mechanism supporting the employed change of information, and the like. The structure of such computational network need not be limited to predefined sets of computers or virtual computers, but can equally include a computer cloud offering computation services in a non-predefined hardware configuration, and the like. The employed computer systems can communicate with one or more database servers offering access to contract and other input data, and provide services to store any results or information deducted from results, as needed.

In FIG. 1, the components and/or steps employed to produce forecasts for financial statement distributions are shown. The model starts (step 100) by reading input data (steps 102, 104, 108) and starting simulation based on stochastic model (step 106). Investment plan definitions (step 102) and investment plan (step 104) affect the way cash flows appear in the model. Optional data and variables (step 106) provides desired simulated or other financial data as input for the model. Simulation is run simulation step by simulation step (step 116) until decision point (step 118) is reached. In decision point (step 118), desired information according to financial formulas (step 110), such as financial statements and rations are generated from simulated and forecasted data, and decision rules (step 112) can be applied to change the course of simulation. Decision rules (step 112) can be applied separately for each simulation round. If the simulation hasn't reached the final step, the simulation continues again until a new decision point (step 116) or until simulation end is reached. If one wishes to change model parameters, the simulation can be rerun. By keeping the random number generator's seed constant, one is able to measure the affect of the model change without noise from using different set of random numbers.

In FIG. 2, the input and output with intermediary results are shown. Employed elements include input are investment plan definitions (step 102), investment plan (step 104), stochastic model (step 106), optional data and variables (step 108), financial formulas (step 110), and decision rules (step 112). The simulation provides directly probability distributions for cash-flows (step 210), financial figures (step 208), and technical data (step 212). An example of technical data can be simulated or computed factory utilization rates, and the like. Derived results can include cash-flow forecasts (step 214), market values of investment (step 216), values of embedded option (step 218), such as a bi-fuel option, and the like, optimal investment plan (step 220), optimal decision making rules (step 222), and optimal hedging strategy (step 224). To obtain optimal values or strategies, one can rerun the simulation model with altered input. The method presented is not restricted to any particular way or method of how optimal (or better) alternatives are searched for.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, cloud computing networks, a combination thereof, and the like.

It is to be understood that the described devices and subsystems are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, pigeons, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

The systems and methods of FIGS. 1-2 can employ object oriented model definitions, wherein with a suitable toolbox users need not write any procedural program code, but rather can define variables that exist in a given model and provide technical instructions for the simulation thereof, by employing the teachings of the present invention, as will be appreciated by those of ordinary skill in the relevant art(s).

Although the systems and methods of FIGS. 1-2 are described in terms of being employed for contracts, and the like, the systems and methods of FIGS. 1-2 can be employed with other types of applications, such as stock market applications, banking applications, and the like, where modeling and analytics are advantageous, by employing the teachings of the present invention, as will be appreciated by those of ordinary skill in the relevant art(s).

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for analyzing stochastic characteristics, comprising:
one or more subsystems for forecasting financial, economical and technical variables' probability distributions and configured for:
analyzing investments, investment plans and portfolios of those without simplifying embedded real options;
analyzing investments, investment plans and portfolios of those allowing state dependent decision making during the analysis changing its course dynamically;
analyzing investments, investment plans and portfolios of those by creating net asset value distributions thereof without simplifications; and
modeling to study effects of model specification changes by implementing new model definitions and by rerunning the model with constant random number generator seed.

2. A method for analyzing stochastic characteristics using one or more subsystems for forecasting financial, economical and technical variables' probability distributions, the method comprising:
analyzing investments, investment plans and portfolios of those without simplifying embedded real options;
analyzing investments, investment plans and portfolios of those allowing state dependent decision making during the analysis changing its course dynamically;
analyzing investments, investment plans and portfolios of those by creating net asset value distributions thereof without simplifications; and
modeling to study effects of model specification changes by implementing new model definitions and by rerunning the model with constant random number generator seed.

3. A computer program product including tangible, non-transitory computer readable instructions for analyzing stochastic characteristics using one or more subsystems for forecasting financial, economical and technical variables' probability distributions and configured to cause one or more computer processors to perform the steps of:
analyzing investments, investment plans and portfolios of those without simplifying embedded real options;
analyzing investments, investment plans and portfolios of those allowing state dependent decision making during the analysis changing its course dynamically;
analyzing investments, investment plans and portfolios of those by creating net asset value distributions thereof without simplifications; and
modeling to study effects of model specification changes by implementing new model definitions and by rerunning the model with constant random number generator seed.
